(19) United States
(12) Patent Application Publication
(10) Pub. No.: US 2015/0085162 A1
(43) Pub. Date: Mar. 26, 2015

(54) PERCEPTUAL RADIOMETRIC COMPENSATION SYSTEM ADAPTABLE TO A PROJECTOR-CAMERA SYSTEM

(71) Applicant: National Taiwan University, Taipei (TW)

(72) Inventors: Tai-Hsiang HUANG, Taipei (TW); Ting-Chun Wang, Taipei (TW); Kuang-Tsu Shih, Taipei (TW); Homer H. CHEN, Taipei (TW)

(21) Appl. No.: 14/466,799

(22) Filed: Aug. 22, 2014

Related U.S. Application Data
(60) Provisional application No. 61/960,604, filed on Sep. 23, 2013.

(51) Int. Cl. H04N 9/64; H04N 5/232; H04N 5/235

(52) U.S. Cl. CPC H04N 9/646; H04N 5/2351; H04N 5/23293
USPC 348/234

(57) ABSTRACT

A perceptual radiometric compensation system adaptable to a projector-camera system includes a brightness scaling unit that scales down brightness of an input image and obtains appearance attributes by a color appearance model (CAM). A hue adjustment unit adjusts hue of the input image toward tone of a colored projection surface by the CAM.

### CROSS-REFERENCE TO RELATED APPLICATIONS

This application claims the benefit under 35 U.S.C. 119 of U.S. Provisional Application No. 61/960,604, filed on Sep. 23, 2013 and entitled Compensation of the Effect of Colored Surface on Image Appearance, the entire contents of which are hereby expressly incorporated by reference.

### BACKGROUND OF THE INVENTION

1. Field of the Invention

The present invention generally relates to a projector-camera system, and more particularly to a perceptual radiometric compensation system adaptable to a projector-camera system.

2. Description of Related Art

Ubiquitous projection, meaning being able to project an image anywhere, is no longer a fiction due to the miniaturization of projectors. With an embedded projector, mobile or wearable devices can project an image on any nearby surface such as wall, desktop, floor, clothes, or palm. However, most surfaces in our living environment are not conditioned for image projection. Besides geometric deformation, color distortion is inevitably introduced to the projection. For example, when an image is projected on a wood-top desk, the grain pattern of the wood would blend with the image and change the image appearance. Similarly, when the projection surface is a non-white wall, the color and texture of the wall would affect the color appearance of the image. Radiometric compensation is needed to combat such color distortion.

Whether the image colors can be properly displayed on a projection surface has to do with the spatial relation between the image gamut and the gamut of the projection surface. If the image gamut is not entirely inside the gamut of the projection surface, color clipping would occur and result in noticeable image artifact. This is illustrated in FIG. 1A and FIG. 1B. Specifically, as shown in FIG. 1A, since the gamut of the image lies completely within the gamut of the ideal white projection surface, there is no color clipping. As shown in FIG. 1B, when the target gamut of radiometric compensation is not entirely enclosed by the gamut of the color projection surface, color clipping is bound to happen. For ubiquitous projection, the gamut of the image on an ideal white projection surface serves as the target gamut, which often falls outside or across the boundary of the projection surface gamut. To properly reproduce the appearance of an image on a color projection surface, radiometric compensation normally manipulates the image gamut with respect to the gamut of the projection surface to avoid color clipping as much as possible.

The methods for reducing color clipping artifact can be divided into two categories: the multi-projector approach and the single-projector approach. The former expands the gamut of the projection surface by superimposing the images projected from a number of projectors. Color reproduction is achieved at the expense of system complexity and cost. The latter basically involves a scaling operation that shrinks and moves the gamut toward the apex of the color cone, as shown in FIG. 1C. Obviously, as a result of the scaling, the compensated image becomes dimmer.

Besides the physical color signal, perceptual properties of human visual system (HVS) have to be considered for ubiquitous projection. The fact that our eyes automatically adapt to the display environment unfortunately has a flip side for the applications considered here in that a color would appear differently when it is surrounded by a different color background.

### SUMMARY OF THE INVENTION

In view of the foregoing, it is an object of the embodiment of the present invention to provide a perceptual radiometric compensation system adaptable to a projector-camera (procam) system. The perceptual radiometric compensation system of the embodiment is capable of effectively performing radiometric compensation to solve color blending and reduce color artifacts by taking into consideration the characteristic of human visual system (HVS).

According to one embodiment, a perceptual radiometric compensation system includes a brightness scaling unit and a hue adjustment unit. The brightness scaling unit is configured to scale down brightness of an input image and to obtain appearance attributes by a color appearance model (CAM). The hue adjustment unit is configured to adjust hue of the input image toward tone of a colored projection surface by the CAM.

### BRIEF DESCRIPTION OF THE DRAWINGS

FIG. 1A and FIG. 1B illustrate color clipping by the spatial relation between the image gamut and the projection surface gamut in a 3D color space;

FIG. 1C illustrates gamut scaling;

FIG. 2A shows a block diagram illustrated of a procam system;

FIG. 2B shows a flow diagram illustrating steps performed by the procam system of FIG. 2A;

FIG. 3 shows a block diagram illustrated of a perceptual radiometric compensation system adaptable to the procam system of FIG. 2A according to one embodiment of the present invention;

FIG. 4 shows a flow diagram illustrating steps performed by the brightness scaling unit or the hue adjustment unit of FIG. 3;

FIG. 5 shows a detailed block diagram of the brightness scaling unit or the hue adjustment unit of FIG. 3;

FIG. 6 illustrates the gamut shifting and scaling method adopted in the embodiment; and

FIG. 7 shows a block diagram illustrated of a simplified compensation system according to another embodiment of the present invention.

### DETAILED DESCRIPTION OF THE INVENTION

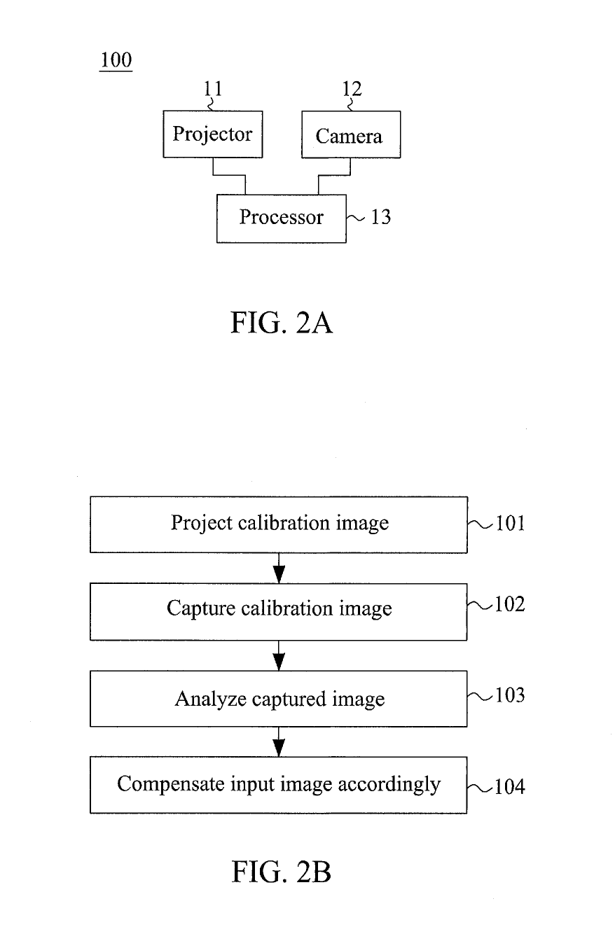

FIG. 2A shows a block diagram illustrated of a projector-camera (procam) system 100, to which the present invention may be adapted. The procam system 100 includes a projector 11, a camera 12 and a processor 13 (or a computer). FIG. 2B shows a flow diagram illustrating steps performed by the procam system 100. In step 101, a calibration image comprised of at least one calibration pattern is first projected on a projection surface, which is generally a non-white (or colored) projection surface. Next, in step 102, the camera 12 captures the projected calibration image, which is then analyzed by the processor 13 (such as a digital image processor), in step 103, to identify the characteristics of the projection surface. Finally, in step 104, an input image to be projected is compensated according to the identified characteristics to counteract the color blending or other artifacts due to the imperfection of the projection surface.

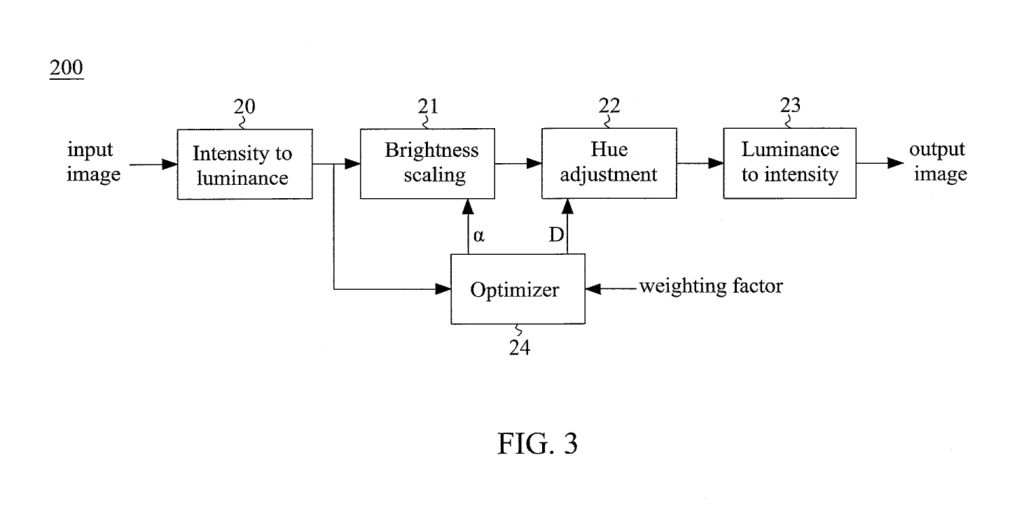

FIG. 3 shows a block diagram illustrated of a perceptual radiometric compensation system (compensation system hereinafter) 200 adaptable to the procam system 100 according to one embodiment of the present invention. The compensation system 200 may be performed by a processor such as a digital image processor. It is noted that some blocks (e.g., blocks 21 and 22) of the compensation system 200 may be executed in an inverse order or be executed concurrently.

In the embodiment, the compensation system 200 includes an intensity-to-luminance transform unit 20 that is configured to transform an intensity of an input image to a luminance value (e.g., red (R), green (G) or blue (B) value) on a white projection surface. It is noted that the intensity-to-luminance transform unit 20 may be unnecessary when an adopted color appearance model (will be described later) is not based on the luminance value.

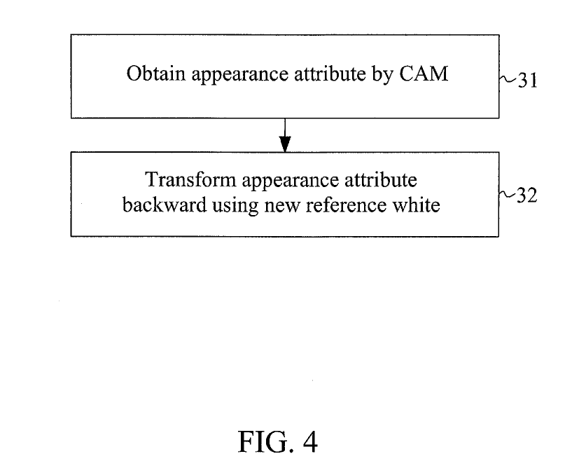

The compensation system 200 also includes a brightness scaling unit 21 that is configured to scale down brightness of the input image. The brightness scaling aims at dimming the input image while preserving the color appearance of it as much as possible. FIG. 4 shows a flow diagram illustrating steps performed by the brightness scaling unit 21 of FIG. 3. Specifically, in step 31, appearance attributes of visual sensation to the input image are obtained by exploiting a color appearance model (CAM), where a reference white is specified as the highest luminance of the input image based on anchoring theory. The CAM is adopted to provide a mathematical formulation of the relationship between physically measurable quantities of stimuli and appearance attributes of visual sensation. According to the anchoring theory, humans perceive a color in a scene with respect to an anchor point, which may be the point of the highest luminance. Instead of physical values such as luminance measureable by equipment, we subjectively perceive appearances such as lightness when we look at an object. In a specific embodiment, the CAM adopted is CIECAM02, a color appearance model published in 2002 and ratified by the International Commission on Illumination (CIE) Technical Committee.

Next, in step 32, luminance of the reference white is scaled down, and the scaled reference white is used as a new reference white to transform the appearance attributes of visual sensation backward. Since the color appearance of the input image should be preserved as much as possible for the brightness scaling unit as mentioned above, the appearance attributes of visual sensation would not be modified. Instead, the luminance of the reference white is manipulated in the backward transformation of step 32 to change the luminance of the input image without affecting the color appearance of the input image.

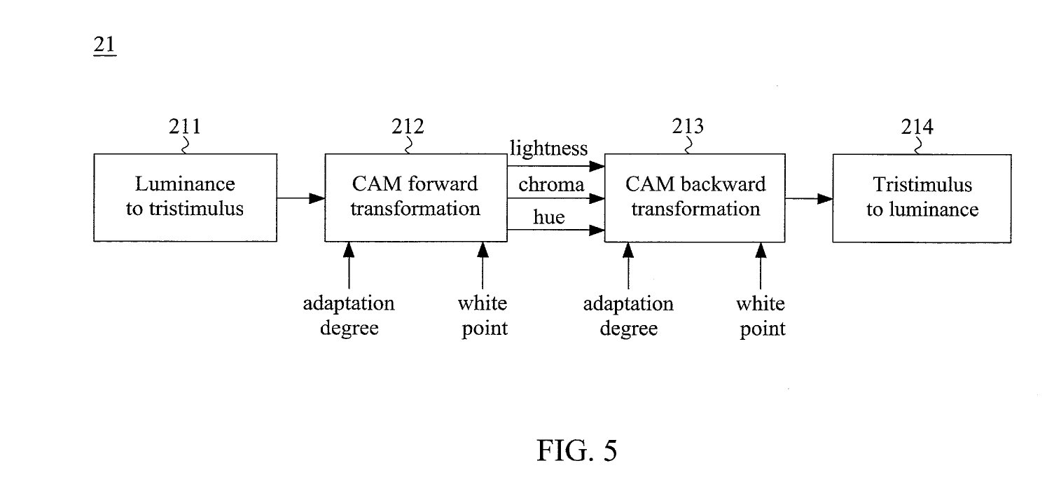

FIG. 5 shows a detailed block diagram of the brightness scaling unit 21 of FIG. 3. Specifically, the brightness scaling unit 21 includes a luminance-to-tristimulus transform subunit 211 that is configured to transform the luminance value to a tristimulus value, for example, associated with XYZ color space. It is noted that, before performing the luminance-to-tristimulus transform subunit 211, the luminance value may be normalized.

The scaling unit 21 also includes a CAM forward transformation subunit 212 implemented, for example, by CIECAM02. The largest tristimulus value T_{W} is identified as the original anchor. The CAM forward transformation subunit 212 is configured to perform on the transformed tristimulus value associated with the white projection surface with respect to the original anchor, using T_{W} as a white point input, thereby deriving the appearance attributes.

In the embodiment, CIECAM02 may derive the following appearance attributes:
Brightness: The attribute according to which an area appears to emit more or less light than a surrounding area.
Lightness: The brightness of an area judged relative to the brightness of a similarly illuminated area that appears to be white.
Colorfulness: The attribute according to which the perceived color of an area appears to be more or less chromatic than the surround area.
Chroma: The colorfulness of an area judged as a proportion of the brightness of a similarly illuminated area that appears white.
Hue: The degree to which a stimulus can be described as similar to or different from stimuli that are described as red, green, and yellow.
Saturation: The colorfulness of an area judged in proportion to its brightness.

It is noted that the lightness, the chroma and the hue are used in the brightness scaling unit 21 as shown in FIG. 5.

The brightness scaling unit 21 further includes a CAM backward transformation subunit 213 (e.g., CIECAM02) that is configured to perform on the appearance attributes with respect to the new anchor, using a T_{W} as a white point input, where a is a brightness scaling factor, thereby deriving the tristimulus value, for example, associated with XYZ color space.

In the embodiment, model CIECAM02 has a white point node that receives a reference white as the anchor for obtaining appearance attributes of an input color with respect to the reference white. The model CIECAM02 also has an adaptation degree D node that receives degree of chromatic adaptation, ranging from 0 for no adaptation to 1 for complete adaptation. In the embodiment, the CAM forward transformation subunit 212 and the CAM backward transformation subunit 213 receive adaptation degree D of 1. The model CIECAM02 may be implemented in two ways. In the forward manner as in the CAM forward transformation subunit 212, the model outputs the appearance attributes of a color for a given reference white. In the backward manner as in the CAM backward transformation subunit 213, the model generates a color using the appearance attributes and the reference white.

The brightness scaling unit 21 includes a tristimulus-to-luminance transform unit 214 (i.e., an inverse of the luminance-to-tristimulus transform unit 211) that is configured to transform the tristimulus value back to the luminance value (e.g., R, G or B value) on the colored projection surface.

Referring back to FIG. 3, according to another aspect of the embodiment, the compensation system 200 further includes a hue adjustment unit 22 that is configured to adjust hue of the input image toward tone of the colored projection surface. As color of a projected image would appear bias toward complementary color of the projection surface due to chromatic adaptation of human visual system (HVS), hue adjustment performed by the hue adjustment unit 22 may correct perceived color of the projected image. Moreover, the hue adjustment may benefit brightness and colorfulness of the input image.

The hue adjustment unit 22 of the embodiment may perform steps similar to those shown in FIG. 4 and may include a detailed block diagram similar to that shown in FIG. 5. Specifically, in step 31, appearance attributes of visual sensation to the input image are obtained by exploiting a color appearance model (CAM), where a reference white is specified as the highest luminance of the input image. Next, in step 32, the appearance attributes of visual sensation are transformed backward with respect to a new reference white \tilde{T}_{W} associated with the colored projection surface. Regarding the hue adjustment unit 22, the CAM forward transformation subunit 212 uses T_{W} as a white point input, and the CAM backward transformation subunit 213 uses \tilde{T}_{W} as a white point input. In the embodiment, the CAM forward transformation subunit 212 and the CAM backward transformation subunit 213 of the hue adjustment unit 22 receive a specific adaptation degree D. The larger the value of D, the more hue adjustment is performed.

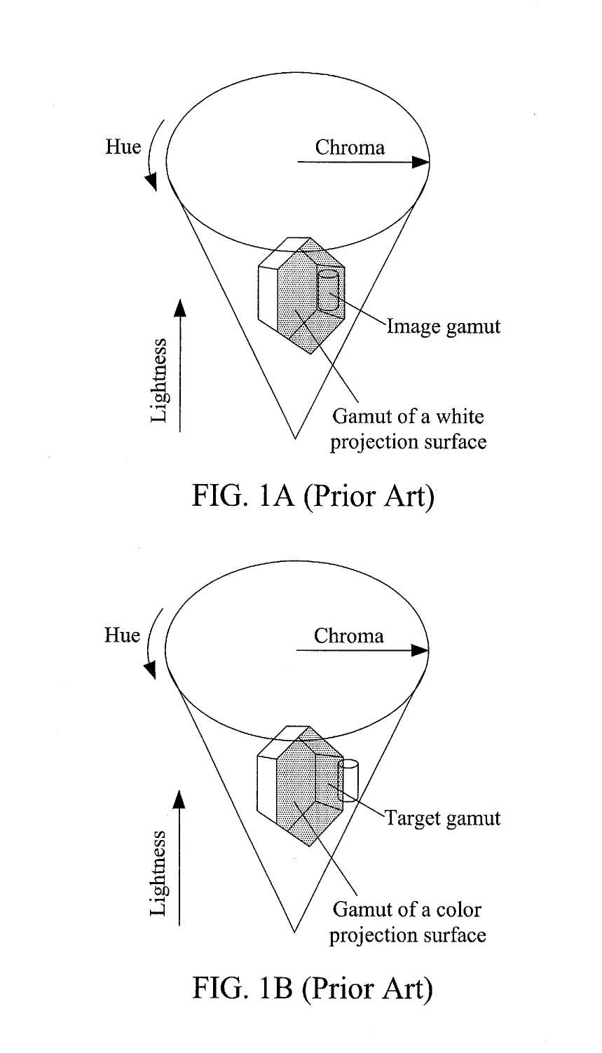

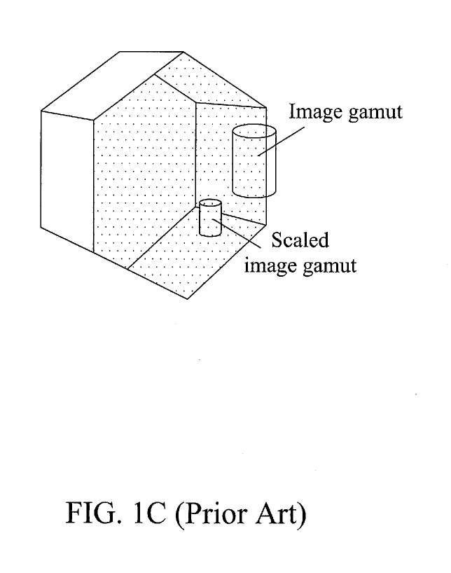

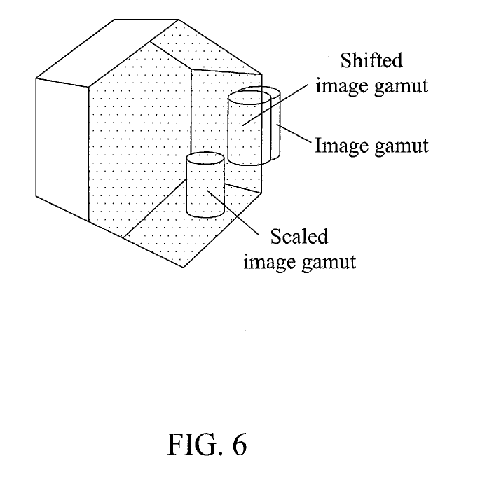

FIG. 6 illustrates the gamut shifting and scaling method adopted in the embodiment. The shifted and scaled image gamut in the embodiment may be higher (image is brighter) and larger (image is more colorful) than the scaled image gamut in FIG. 1C.

Referring back to FIG. 3, the compensation system 200 include a luminance-to-intensity transform unit 23 that is configured to transform the luminance value to an intensity of an output image to be projected on the colored projection surface. It is noted that the luminance-to-intensity transform unit 23 may be unnecessary when an adopted color appearance model is not based on the luminance value.

As shown in FIG. 3, the amount of the hue adjustment (i.e., the adaptation degree D) and the brightness scaling (i.e., the brightness scaling factor α) may be determined through an optimization by an optimizer 24, which strikes a balance between image brightness, hue correctness, and the amount of clipping artifact. Specifically, an optimization may be formulated below to find optimal values of a and D that minimize the distortions in the radiometric compensated output image:

$$( α , D ) = {arg min}_{α , D} \{ {w}_{1} [ {( 1 - α )}^{2} + {w}_{2} {D}^{2} ] + E \}$$

where (1-−α) accounts for brightness reduction of the resulting output image, D accounts for the amount of hue adjustment, and E accounts for the amount of clipping artifact in the radiometric compensated output image, which may be calculated by:

$$E = {\sum }_{i} l \{ {p}_{i} > U \} {( {p}_{i} - U )}^{2} / \vert I \vert$$

where l is an indicator function, pᵢ is a luminance value of pixel i, U is an upper bound of the projector's dynamic range, and |I| denote an image size.

The goal of this optimization is to find optimal amounts of brightness scaling and hue adjustment that minimize undesirable brightness reduction, hue distortion, and color clipping. The weighting factors w₁ and w₂ may be determined through a subjective experiment.

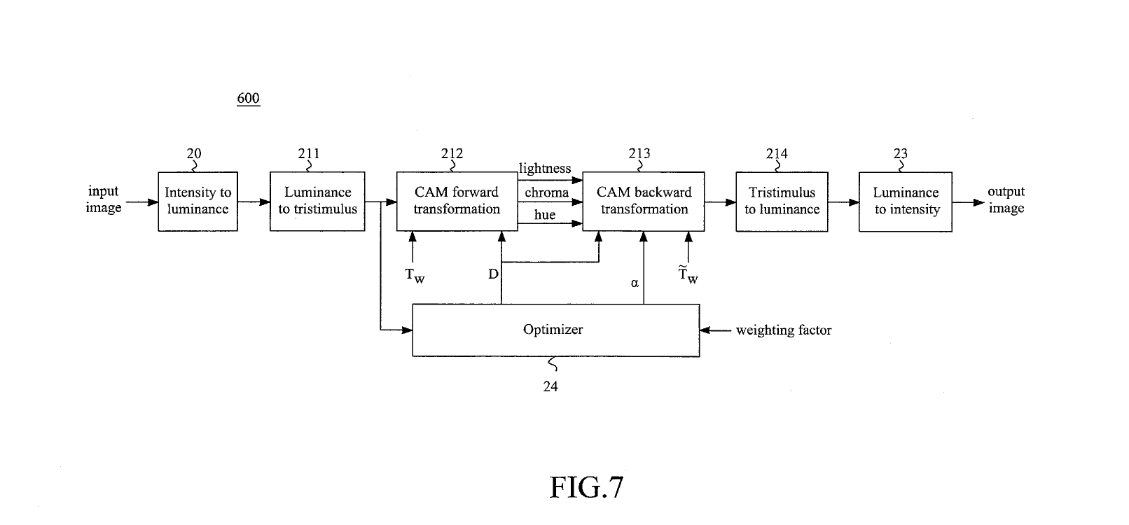

As both the brightness scaling unit 21 and the hue adjustment unit 22 take advantage of a color appearance model (CAM) such as CIECAM02 model, the brightness scaling unit 21 and the hue adjustment unit 22 may be combined into one transformation, thus simplifying the architecture and reducing half of the work. FIG. 7 shows a block diagram illustrated of a simplified compensation system 600, in which the brightness scaling and hue adjustment are concurrently performed. In this embodiment, the CAM forward transformation subunit 212 uses T_{W} as the white point, and the CAM backward transformation subunit 213 uses α \tilde{T}_{W} as the white point. Both the CAM forward transformation subunit 212 and the CAM backward transformation subunit 213 receive a specific adaptation degree D less than 1. The values of α and D may be determined through an optimization by the optimizer 24 as described above.

Although specific embodiments have been illustrated and described, it will be appreciated by those skilled in the art that various modifications may be made without departing from the scope of the present invention, which is intended to be limited solely by the appended claims.

What is claimed is:

1. A perceptual radiometric compensation system adaptable to a projector-camera system, the compensation system comprising:
a brightness scaling unit configured to scale down brightness of an input image and to obtain appearance attributes by a color appearance model (CAM); and
a hue adjustment unit configured to adjust hue of the input image toward tone of a colored projection surface by the CAM.

2. The compensation system of claim 1, wherein the brightness scaling unit dims the input image while preserving color appearance of the input image.

3. The compensation system of claim 1, wherein the brightness scaling unit comprises:
a luminance-to-tristimulus transform subunit configured to transform a luminance value to a tristimulus value;
a CAM forward transformation subunit configured to perform on the tristimulus value associated with a white projection surface with respect to an original anchor, thereby deriving appearance attributes;
a CAM backward transformation subunit configured to perform on the appearance attributes with respect to a new anchor, thereby deriving the tristimulus value; and
a tristimulus-to-luminance transform unit configured to transform the tristimulus value back to the luminance value.

4. The compensation system of claim 3, wherein a largest tristimulus value is used as a white point input to the CAM forward transformation subunit and is identified as the original anchor, and the largest tristimulus value is scaled down and used as a white point input to the CAM backward transformation subunit and is identified as the new anchor.

5. The compensation system of claim 1, wherein the hue adjustment unit comprises:
a luminance-to-tristimulus transform subunit configured to transform a luminance value to a tristimulus value;
a CAM forward transformation subunit configured to perform on the tristimulus value associated with a white projection surface with respect to an original anchor, thereby deriving appearance attributes;
a CAM backward transformation subunit configured to perform on the appearance attributes associated with the colored projection surface with respect to a new anchor, thereby deriving the tristimulus value; and
a tristimulus-to-luminance transform unit configured to transform the tristimulus value back to the luminance value on the colored projection surface;
wherein the CAM forward transformation subunit and the CAM backward transformation subunit each receives an adaptation degree in order to adjust hue of the input image toward tone of the colored projection surface.

6. The compensation system of claim 1, wherein the color appearance model comprises CIECAM02 ratified by International Commission on Illumination (CIE) Technical Committee.

7. The compensation system of claim 1, wherein the appearance attributes comprise lightness, chroma and hue.

8. The compensation system of claim 1, wherein the luminance value comprises a red, green or blue value, and the tristimulus value is associated with XYZ color space.

9. The compensation system of claim 1, further comprising:
an intensity-to-luminance transform unit configured transform an intensity of the input image to a luminance value; and
a luminance-to-intensity transform unit configured to transform the luminance value to an intensity of an output image to be projected on the colored projection surface.

10. A perceptual radiometric compensation system adaptable to a projector-camera system, the compensation system comprising:
a luminance-to-tristimulus transform subunit configured to transform a luminance value to a tristimulus value;
a color appearance model (CAM) forward transformation subunit configured to perform on the tristimulus value to derive appearance attributes associated with a white projection surface, a largest tristimulus value being used as a white point input to the CAM forward transformation subunit;
a CAM backward transformation subunit configured to perform on the appearance attributes associated with a colored projection surface to derive a tristimulus value, a largest tristimulus value associated with the color projection surface being scaled down and used as a white point input to the CAM backward transformation subunit; and
a tristimulus-to-luminance transform unit configured to transform the tristimulus value back to the luminance value;
wherein the CAM forward transformation subunit and the CAM backward transformation subunit each receives an adaptation degree in order to adjust hue of the input image toward tone of the colored projection surface.

11. The compensation system of claim 10, further comprising an optimizer configured to provide the adaptation degree, and a scaling factor that is used to scale down the largest tristimulus value.

12. The compensation system of claim 10, wherein the color appearance model comprises CIECAM02 ratified by International Commission on Illumination (CIE) Technical Committee.

13. The compensation system of claim 10, wherein the appearance attributes comprise lightness, chroma and hue.

14. The compensation system of claim 10, wherein the luminance value comprises a red, green or blue value, and the tristimulus value is associated with XYZ color space.

15. The compensation system of claim 10, further comprising:
an intensity-to-luminance transform unit configured to transform an intensity of the input image to the luminance value; and
a luminance-to-intensity transform unit configured to transform the luminance value to an intensity of an output image to be projected on the colored projection surface.
